(19) United States
(12) Patent Application Publication
(10) Pub. No.: US 2005/0081585 A1
(43) Pub. Date: Apr. 21, 2005

(54) Vehicle security device

(76) Inventors: John Edwin James Jones, Banbury Oxon OX16 (GB); Deborah Jane Jones, Banbury Oxon OX16 (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/502,690

(22) PCT Filed: Jan. 27, 2003
(86) PCT No.: PCT/GB03/00326

(30) Foreign Application Priority Data
Jan. 28, 2002 (GB) 0201873.7

(51) Int. Cl. E05B 13/00

(52) U.S. Cl. 70/424; 70/455

(57) ABSTRACT

A security device for a member, such as a door 11, displaceable between a closed and an open position, the device—providing for the blocking of access to an operating means for the member, such as a handle or key entry, the device comprising: an anchorage member 20 mounting on the member as aforesaid with the member in an open position, at a working location in the vicinity of the operating means; a padlock 30 for attachment to the anchorage; and a housing 40 for attachment to the anchorage by way of the pad lock when the anchorage is attached to the door in the working location so that housing extends to cover the operating means; the housing including—a recess 42 to receive the padlock so that the padlock is shrouded by the housing; means (acting via 43) for securing the padlock to the housing when the padlock is located in the recess; means 44 for accessing an operating means, such as a key hole, for the padlock when shrouded by b the housing; to enable the padlock, when secured in the recess, to demountably retain the combined housing and pad lock to the anchorage.

### TECHNICAL FIELD

This invention relates to a vehicle security method and device. It is particularly concerned with the security of a road vehicle. However the method is applicable to vehicles other than road vehicles as will become apparent.

### BACKGROUND ART

The present invention is concerned with preventing unauthorised access to door handles or key holes provided on doors to govern access to an interior of, for example, a vehicle though the invention is not limited to vehicle doors. In connection with motor vehicles it is known to bodily remove a lock from its housing by powerful, but portable, withdrawal means using leverage or hydraulic power.

In my co-pending Application 00 26309.5 there is described a vehicle security device serving to resist unauthorised entry to the interior of a vehicle through a window opening.

The present invention can be used in combination with the device of the earlier application to provide for increased security.

### DISCLOSURE OF INVENTION

According to the present invention there is provided a security device for a member, such as a door, displaceable between a closed and an open position, the device—providing for the blocking of access to an operating means for the member, such as a handle or key entry, the device comprising:
an anchorage member mounting on the member as aforesaid with the member in an open position, at a working location in the vicinity of the operating means;
a padlock for attachment to the anchorage; and
a housing for attachment to the anchorage by way of the pad lock when the anchorage is attached to the door in the working location so that housing extends to cover the operating means; the housing including
a recess for to receive the padlock so that the padlock is isolated shrouded by the housing;
means for securing the padlock to the housing when the padlock is located in the recess;
means for accessing an operating means, such as a key hole, for the padlock when shrouded by the housing; to enable the padlock, when secured in the recess, to demountably retain the combined housing and pad lock to the anchorage.

According to a first preferred version of the present invention the security device includes detector means for generating an alarm in the event that an unauthorised attempt is made to remove the device from a working location. Typically the detector means includes a movement or impact sensitive device which, on triggering, causes a local alarm to be generated and/or transmits an alarm signal to a receiver at a local or remote security center.

### BRIEF DESCRIPTION OF DRAWINGS

An exemplary embodiment of the invention will now be described with reference to the accompanying drawings of which:

FIG. 1 is a perspective view of a vehicle door;

FIG. 2 shows a first component of the security device viewed from the rear;

FIG. 2A shows the component of FIG. 2 vied from the front;

FIG. 3 shows a second component of the security device from the side;

FIG. 3A shows the component of FIG. 3 viewed from the front;

FIG. 4 shows a housing for the security device viewed from the side; and

FIG. 4A shows the component of FIG. 4 in enlarged form.

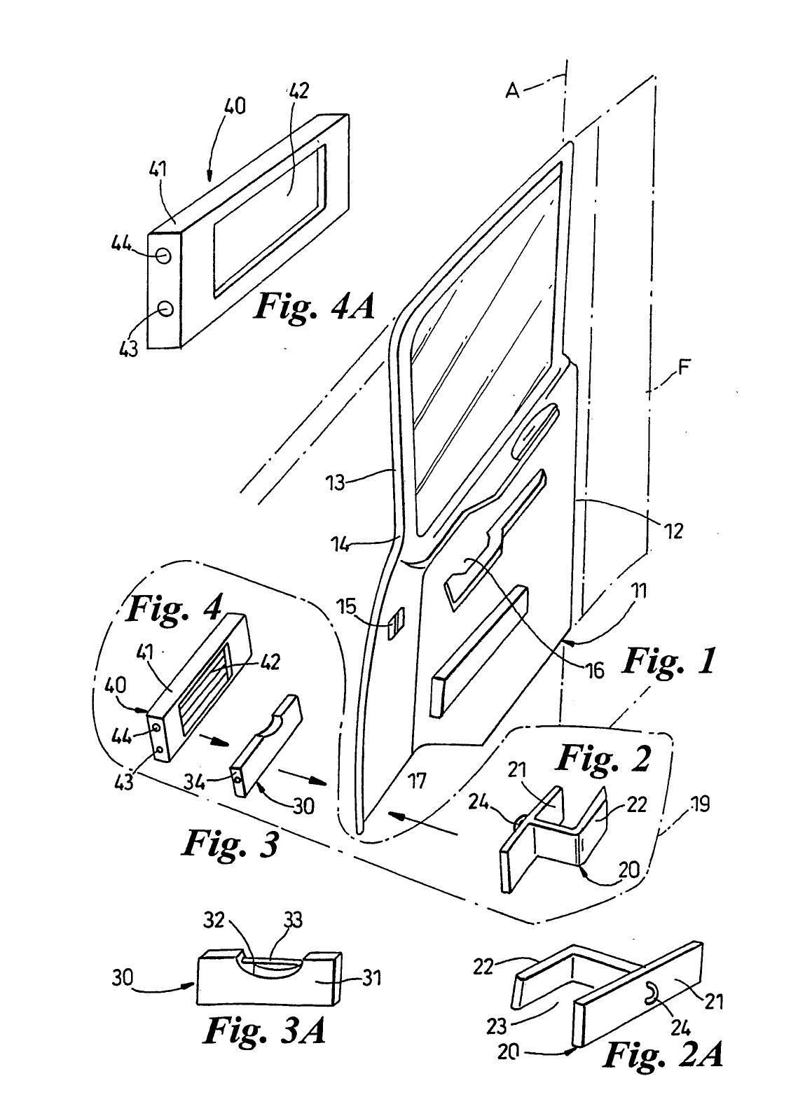

FIGS. 1, 2, 3 and 4 are disposed relative to one another to show an exploded view of the security device.

### MODE FOR CARRYING OUT THE INVENTION

A goods vehicle has a cab equipped with a door 11 mounted on frame F shown in broken outline. The door 11 is hinged towards its leading edge 12 in a conventional manner to rotate about axis A between a closed position (as shown) and an open position allowing access to the cab. Rear edge 13 of the door 11 includes a rim 14. A conventional latch 15 is mounted towards the rear edge 13 of the door which can be opened form the inside of the vehicle by means of a handle 16, Outside panel 17 of the door 11 is provided with an external key hole and handle. A key inserted into the key hole can be used to lock operation of the latch and handle to maintain the door 11 in a closed position. Adjacent the external keyhole (not shown) there is a conventional external door handle in the form of a recessed flap. The door 11 is shown in its closed position lying flush with body frame F.

Security device 19 of the present invention is made up of three parts: anchorage 20 (FIGS. 2, 2A); padlock 30 (FIGS. 3, 3A) and housing 40. (FIGS. 4, 4A).

Anchorage 20 (FIG. 2, 2A) is made up of a steel front flat plate 21 to which is welded an L-shaped steel plate 22 to form a crutch 23 by means of which the anchorage 20 can be mounted on the rear edge 13 of the door in the vicinity of the external keyhole and door handle. The anchorage 20 includes a strong integral loop 24.

Padlock 30 (FIGS. 3, 3A) is made up of a rectangular section body 31 having a recess 32 across which extends bar 33. The bar 33 can be locked and unlocked by way of a key inserted in keyhole 34 (FIG. 4A). When unlocked the bar 33 retracts part way back across the recess 32 to release anything retained in the recess 32.

Housing 40 (FIGS. 4, 4A) is made up of a solid body member 41 with a recess 42 of sufficient size to receive and shroud security padlock 30. Bore 43 serves to receive a security bolt whereby the padlock can be secured within the recess 42 in a housed position in which bore 44 provides access to key hole 34 of the padlock.

The security device 19 is readily mounted on door 11. The door 11 is opened and anchorage 20 is presented to the door so that crutch 23 seats about rim 14 with the loop 24 on the outside of the door panel 17. The door 11 is then closed and locked by way of its existing lock. The padlock 30 is then attached to the loop 24 so that the loop is retained in recess 32 by bar 33. The housing 40 is then located over the padlock 30 so that the padlock 30 is enclosed by the recess 42 and with the housing 40 serving to shroud the external handle and keyhole of the door 11. The padlock 30 is secured in the recess 42 of the housing by a security bolt inserted into bore 43. The padlock is then unlocked or locked by inserting a key for the padlock into bore 44.

### INDUSTRIAL APPLICABIITY

The security device 19 provides an effective means for preventing unauthorised access to a vehicle door keyhole (and also the outside handle).

The exemplary embodiment describes a security device for use with a goods vehide door. In substantially similar form the device can be used not only on doors of goods, passenger vehicles and cars and but also on boots or bonnets of such vehicles. The device can be used in a similar way on other vehicles such as boats or aircraft. The device can also be used for static applications such as gates, cabinets, storage enclosures, kiosks, garages or buildings.

The housing 40 can include means for generating an alarm in the event that an unauthorised attempt is made to remove the device 19. Typically this could be a movement or impact sensitive means which, if triggered, could cause a local alarm to be generated and/or transmit a warning signal to a receiver at a local or remote security center.

This application is a national stage completion of PCT/GB03/00326 filed Jan. 27, 2003 which claims priority from British application serial no. 0201873.7 filed Jan. 28 2002.

1. A security device for a member, such as a door, displaceable between a closed and an open position, the device-providing for the blocking of access to an operating means for the member, such as a handle or key entry, the device being characterised by:
an anchorage member mounting on the member as aforesaid with the member in an open position, at a working location in the vicinity of the operating means;
a padlock for attachment to the anchorage; and
a housing for attachment to the anchorage by way of the pad lock when the anchorage is attached to the door in the working location so that housing extends to cover the operating means; the housing including
a recess for to receive the padlock so that the padlock is isolated shrouded by the housing;
means for securing the padlock to the housing when the padlock is located in the recess;
means for accessing an operating means, such as a key hole, for the padlock when shrouded by the housing; to enable the padlock, when secured in the recess, to demountably retain the combined housing and pad lock to the anchorage.

2. A security device as claimed in claim 1 characterised by detector means for generating an alarm in the event that an unauthorised attempt is made to remove the device from a working location.

3. A security device as claimed in claim 2 characterised in that the detector means includes a movement or impact sensitive device which, on triggering, causes a local alarm to be generated and/or transmits an alarm signal to a receiver at a local or remote security center.
